(19) United States
(12) Patent Application Publication
(10) Pub. No.: US 2021/0240724 A1
(43) Pub. Date: Aug. 5, 2021

(54) METHODS AND SYSTEMS FOR DYNAMICALLY UPDATING A USER INTERFACE DISPLAYING AIR TICKETS AVAILABLE FOR PURCHASE

(71) Applicant: TripActions, Inc., Palo Alto, CA (US)

(72) Inventors: Ariel Cohen, Palo Alto, CA (US); Ilan Twig, San Francisco, CA (US); Shawn Wong, Los Angeles, CA (US); Connor Jennings Barnett, Atherton, CA (US); Ruslan Khaydarov, Mountain View, CA (US); Anique Drumright, Palo Alto, CA (US); Felix Milman, Los Gatos, CA (US); Jun Gao, San Jose, CA (US)

(21) Appl. No.: 17/160,646

(22) Filed: Jan. 28, 2021

Related U.S. Application Data
(60) Provisional application No. 62/968,379, filed on Jan. 31, 2020.

(51) Int. Cl. G06F 16/2457; G06Q 50/30; G06F 16/9538

(52) U.S. Cl. CPC G06F 16/24578; G06F 16/9538; G06F 16/24575; G06Q 50/30

(57) ABSTRACT

A method for displaying and dynamically updating a user interface displaying a listing of air tickets available for purchase on a flight includes receiving, by a computing device, a plurality of search results including at least one fare listing for an air ticket for a seat on a flight and unstructured data including at least one rule associated with the search result. The computing device assigns an initial quality rating for each of the plurality of search results. The computing device receives, for each of the plurality of search results, structured data identifying at least one amenity and analyzes the received structured and unstructured data. The computing device assigns a modified quality rating to at least one of the plurality of search results and displays, to a second computing device, an enumeration of each of the plurality of search results categorized based on the quality ratings.

### CROSS-REFERENCE TO RELATED APPLICATIONS

This application claims priority from U.S. Provisional Patent Application No. 62/968,379, filed on Jan. 31, 2020, entitled “Methods and Systems for Dynamically Updating a User Interface Displaying Air Tickets Available for Purchase,” which is hereby incorporated by reference.

### BACKGROUND

The disclosure relates to online travel sites. More particularly, the methods and systems described herein relate to functionality for dynamically updating a user interface displaying a listing of air tickets available for purchase on a flight, the listing categorized based on features associated with the tickets.

The travel industry has seen a proliferation of online travel retailers in both the consumer and corporate travel spaces. With a plethora of sites and agents through which to book, and with companies wanting to control travel expenses, competition for market share is high and prices have seen some downward pressure. A side-effect of the crowded marketplace is that, in an effort to lower prices, flight suppliers (airlines) have created “basic” ticket options with lower price points by removing previously-included services—e.g., checked baggage, meals, etc. Additionally, suppliers have also created more comfortable cabins and added even more amenities to their higher-priced ticket options in an effort to differentiate themselves from their competitors. The bundles of services added and those removed fall under various branding schemes by the airlines and differ from supplier to supplier. This results in a large field of ticketing options with an array of amenities available at all price points. Additionally, purveyors of airline travel generally present results of a flight search as a city pair (origin and destination) and a price, leaving customers to determine what is the best option for them based largely on cost without much information on available amenities. This can result in a traveler not being aware of the amenities “lost” or the extra charges that may be required to “gain back” those services they need/want. When flights are listed this way, the tickets appear to be equal in most respects except price, treating disparate options as fungible. This leads to a commoditization of airline tickets.

Purveyors of airline tickets are also generally eligible for incentive or commission payments for tickets sold. This can create an incentive for the seller to encourage the purchasing of, not what is necessarily best for the traveler, but what maximizes the seller's commission. Corporate travelers and their employers have specific needs and preferences for their travel and generally value convenience and task-oriented scheduling in order to maximize the productivity of the trip and are willing to pay more to meet those goals. The end result of ineffective display of options and commoditization of bookings is that corporate travelers are uninformed as to the full range of booking options, what those bookings include, and may be pointed towards suboptimal options based on the seller's other motivations.

Therefore, there is a need for methods and systems that implement technology for displaying and dynamically updating user interfaces to provide robust feature comparison, quality ranking displays, and improved technological algorithms for ranking flight options.

### BRIEF DESCRIPTION

In one aspect, a method for displaying and dynamically updating a user interface displaying a listing of air tickets available for purchase on a flight, the listing categorized based on features associated with the air tickets, includes receiving, by a first computing device, from a plurality of third-party fare listing systems, a plurality of search results, each search result in the plurality of search results including at least one fare listing for an air ticket for a seat on a flight between an origin and a destination and an identification of a class associated with the air ticket, and unstructured data including at least one rule associated with the search result. The method includes analyzing, by the first computing device, each search result in the plurality of search results. The method includes assigning, by the first computing device, an initial quality rating for each search result in the plurality of search results responsive to the analyzing. The method includes receiving, by the first computing device, from at least one third-party database, for each of the plurality of search results, structured data identifying at least one amenity associated with the search result. The method includes analyzing, by the first computing device, for each of the plurality of search results, the received structured data identifying at least one amenity and the received unstructured data including the at least one rule. The method includes assigning, by the first computing device, a modified quality rating to at least one of the plurality of search results responsive to the analyzing of the received structured data and of the received unstructured data. The method includes categorizing, by the first computing device, the plurality of search results based on the modified quality rating. The method includes displaying, by the first computing device, via a user interface, to a second computing device, an enumeration of each of the plurality of search results categorized based on the quality ratings.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for dynamically updating a user interface displaying a listing of air tickets available for purchase on a flight;

FIG. 1B is a screen shot depicting an embodiment of a display of ticket options generated and updated by a system for dynamically updating a user interface displaying a listing of air tickets available for purchase on a flight;

FIG. 2 is a flow diagram depicting an embodiment of a method for dynamically updating a user interface displaying a listing of air tickets available for purchase on a flight; and

FIGS. 3A-3C are block diagrams depicting embodiments of computers useful in connection with the methods and systems described herein.

### DETAILED DESCRIPTION

The methods and systems described herein may provide functionality for dynamically updating a user interface displaying a listing of air tickets available for purchase on a flight, thus addressing issues of flight commoditization, lack of transparency regarding actual costs and the full range of booking options, and the devaluing of features at the point of purchase. Using the methods and systems described herein allows those purchasing air flight tickets to view user interfaces displaying a full range of options for tickets. The methods and systems described herein may provide a dynamically updated user interface that adds the dimension of quality to flight search results. The methods and systems described herein may both inform customers as to their full range of booking options as well as recommend tickets that confirm with customers' company and personal preferences, enabling them to make travel choices that are the best value for them.

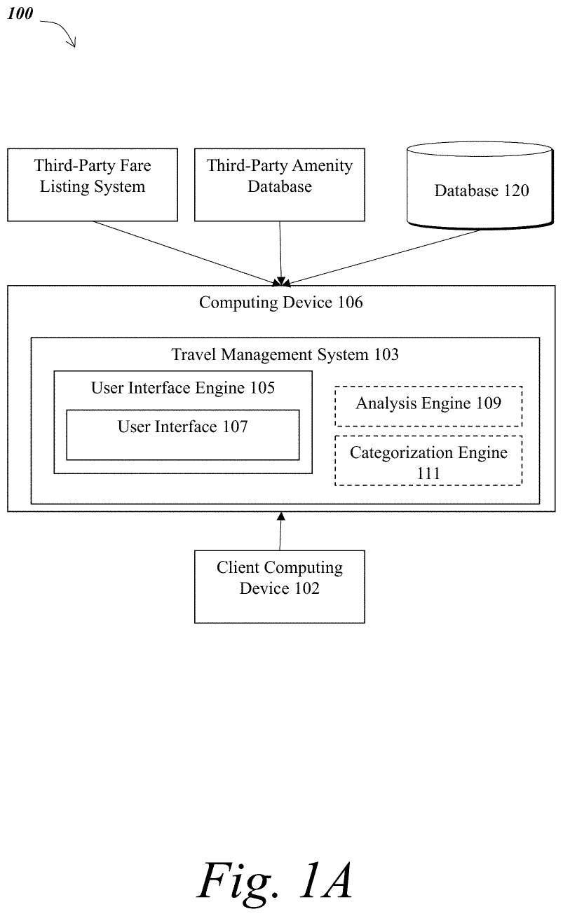

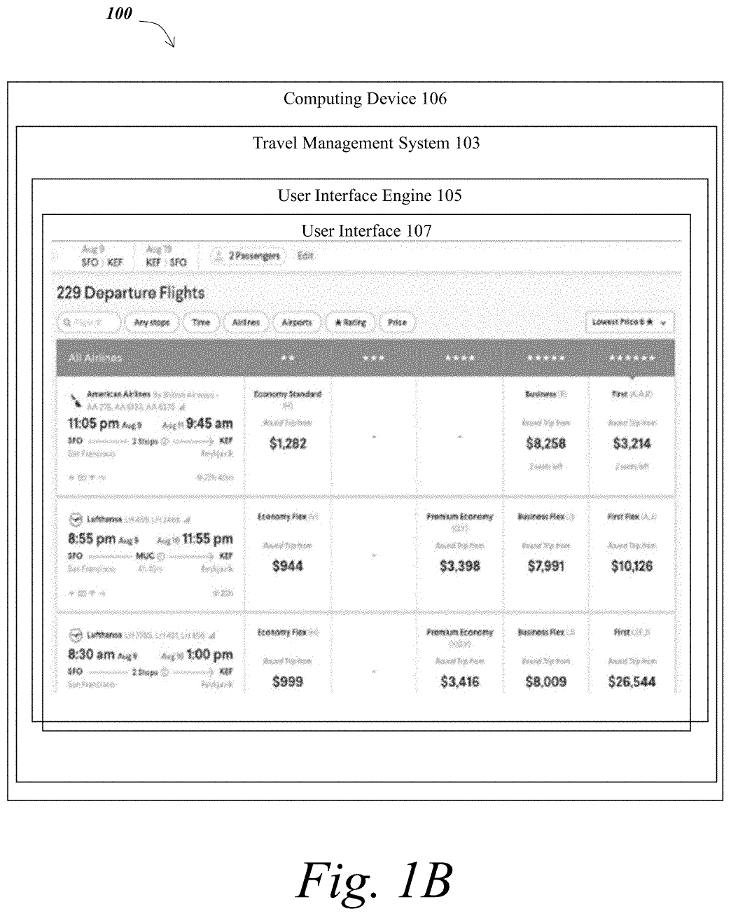

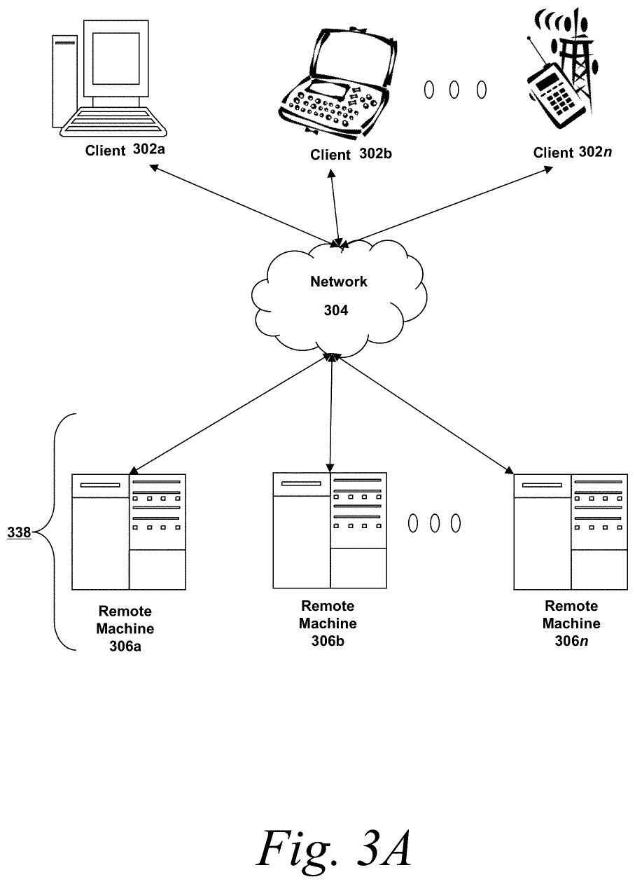

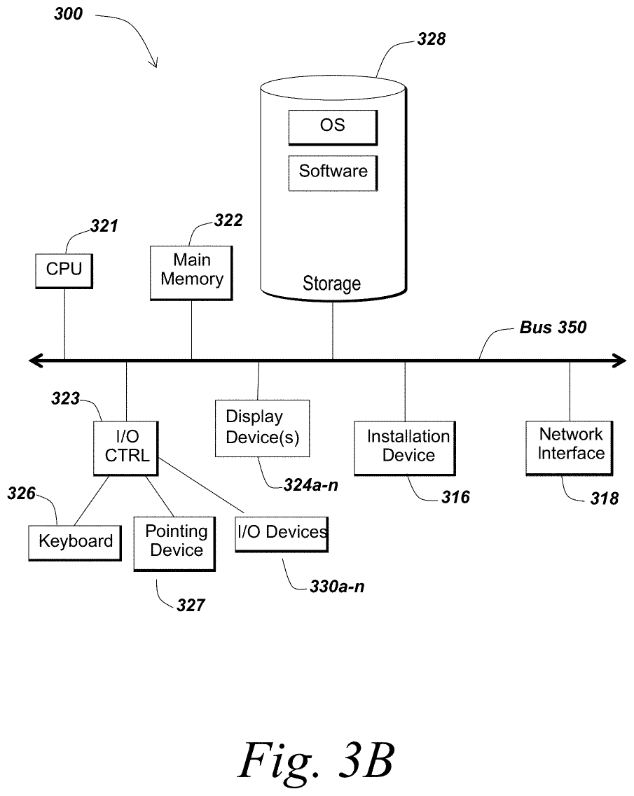

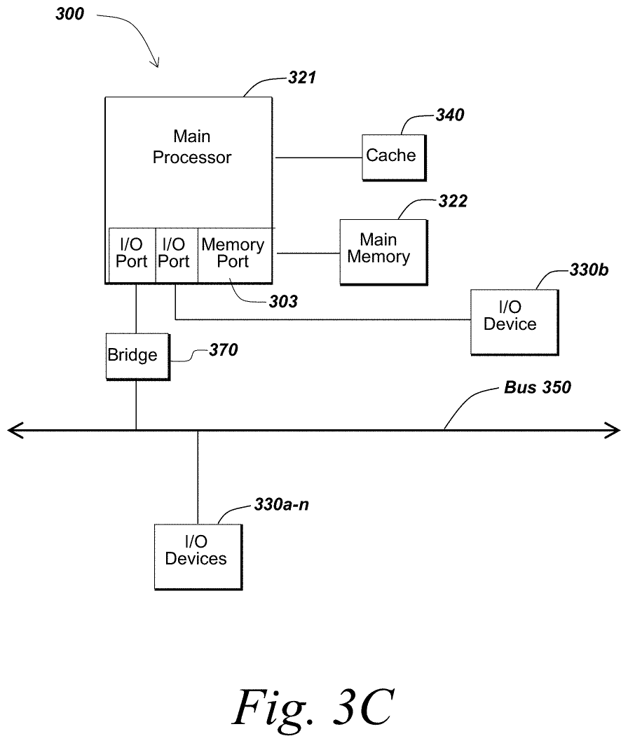

Referring now to FIG. 1A, a block diagram depicts one embodiment of a system for dynamically updating a user interface displaying a listing of air tickets available for purchase on a flight. In brief overview, the system 100 includes a computing device 106, a travel management system 103, a user interface engine 105, a database 120, a third-party fare listing system, a third-party amenity database, and a client computing device 102. The computing device 106 may be a modified type or form of computing device (as described in greater detail below in connection with FIGS. 3A-C) that has been modified to execute instructions for providing the functionality described herein, resulting in a new type of computing device that provides a technical solution to a problem rooted in computer network technology.

The travel management system 103 may be provided as a software component. The travel management system 103 may be provided as a hardware component. The computing device 106 may execute the travel management system 103. The travel management system 103 may execute the user interface engine 105 to generate the user interface 107. The travel management system 103 may optionally execute an analysis engine 109. The travel management system 103 may optionally execute a categorization engine 111.

The user interface engine 105 may be provided as a software component. The user interface engine 105 may be provided as a hardware component. Referring ahead to FIG. 1B, a screen shot depicts an embodiment of a display of ticket options generated and updated by the user interface engine 105 in the system 100. As shown in FIG. 1B, the user interface 107 may display different ticket options presented ticket by ticket and sorted on price, although the user interface may provide functionality for sorting based on other features. In this way, a user may view ticket options on a flight offering economy, business, and first-class ticket options for each flight on which tickets are available. In contrast, conventional systems would require the user to perform three different searches in order to view each of the economy, business, and first-class tickets available for each flight, which means that customers are rarely, if ever, presented with multiple options within a single flight side by side. Furthermore, conventional online travel booking tools typically emphasize price as the main comparison metric for search results, whereas the user interface provided by the methods and systems described herein emphasize quality of the experience as quantified by available features.

Referring back to FIG. 1A, the travel management system 103 may be in communication with the database 120. In some embodiments, the database 120 is an ODBC-compliant database. For example, the database 120 may be provided as an ORACLE database, manufactured by Oracle Corporation of Redwood Shores, Calif. In other embodiments, the database 120 can be a Microsoft ACCESS database or a Microsoft SQL server database, manufactured by Microsoft Corporation of Redmond, Wash. In other embodiments, the database 120 can be a SQLite database distributed by Hwaci of Charlotte, N.C., or a PostgreSQL database distributed by The PostgreSQL Global Development Group. In still other embodiments, the database 120 may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, Md., MongoDB databases distributed by 10Gen, Inc., of New York, N.Y., an AWS DynamoDB distributed by Amazon Web Services and Cassandra databases distributed by The Apache Software Foundation of Forest Hill, Md. In further embodiments, the database 120 may be any form or type of database.

Although, for ease of discussion, the travel management system 103 and the database 120 are described in FIG. 1A as separate modules, it should be understood that this does not restrict the architecture to a particular implementation. For instance, these components may be encompassed by a single circuit or software function or, alternatively, distributed across a plurality of computing devices.

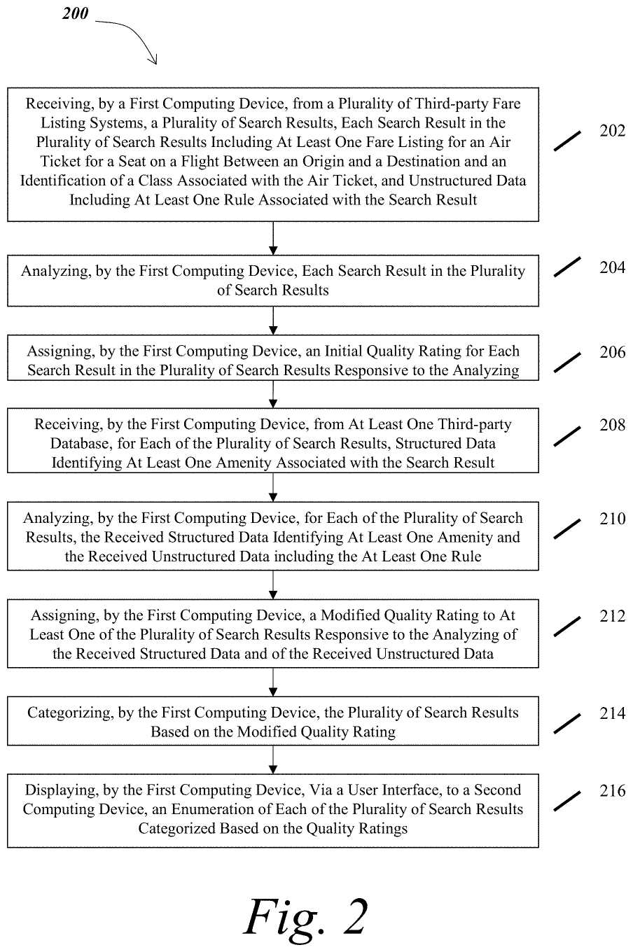

Referring now to FIG. 2, in brief overview, a block diagram depicts one embodiment of a method 200 for dynamically updating a user interface displaying a listing of air tickets available for purchase on a flight, the listing categorized based on features associated with the tickets. The method 200 includes receiving, by a first computing device, from a plurality of third-party fare listing systems, a plurality of search results, each search result in the plurality of search results including at least one fare listing for an air ticket for a seat on a flight between an origin and a destination and an identification of a class associated with the air ticket, and unstructured data including at least one rule associated with the search result (202). The method 200 includes analyzing, by the first computing device, each search result in the plurality of search results (204). The method 200 includes assigning, by the first computing device, an initial quality rating for each search result in the plurality of search results responsive to the analyzing (206). The method 200 includes receiving, by the first computing device, from at least one third-party database, for each of the plurality of search results, structured data identifying at least one amenity associated with the search result (208). The method 200 includes analyzing, by the first computing device, for each of the plurality of search results, the received structured data identifying at least one amenity and the received unstructured data including the at least one rule (210). The method 200 includes assigning, by the first computing device, a modified quality rating to at least one of the plurality of search results responsive to the analyzing of the received structured data and of the received unstructured data (212). The method 200 includes categorizing, by the first computing device, the plurality of search results based on the modified quality rating (214). The method 200 includes displaying, by the first computing device, via a user interface, to a second computing device, an enumeration of each of the plurality of search results categorized based on the quality ratings (216).

Referring now to FIG. 2, in greater detail and in connection with FIGS. 1A-1B, the method 200 includes receiving, by a first computing device, from a plurality of third-party fare listing systems, a plurality of search results, each search result in the plurality of search results including at least one fare listing for an air ticket for a seat on a flight between an origin and a destination and an identification of a class associated with the air ticket, and unstructured data including at least one rule associated with the search result (202). Before receiving the plurality of search results, the computing device 106 may have received a search request for air ticket availability between the origin and the destination and the computing device 106 may have requested, from each of the plurality of third-party fare listing systems, air ticket availability between the origin and the destination. For example, a user of the client computing device 102 may interact with the user interface 107 via a web page to request ticket availability and to receive results from the computing device 106. The user may request a list of flight options that satisfy the user's trip criteria for a particular travel booking (e.g., departure date, return date, origin, and destination). The travel management system 103 may send a query to one or more third-party fare listing systems (e.g., Sabre, Travelfusion), the query including the trip criteria received from the user.

The method 200 includes analyzing, by the first computing device, each search result in the plurality of search results (204). The travel management system 103 may receive a listing of search results that includes basic information about each flight on which air tickets are available for purchase, the basic information including, for example, origin and destination and cabin class (e.g., what cabin the fare or seat is in). The travel management system 103 may analyze each search result and the information associated with each of the search results.

The method 200 includes assigning, by the first computing device, an initial quality rating for each search result in the plurality of search results responsive to the analyzing (206). Assigning the initial quality rating for each search may include identifying, within each search result, an origin and a destination; identifying, within each search result, a cabin class; and assigning the initial quality ranking to the search result based upon the origin, the destination, and the cabin class. By way of example and without limitation, an airline carrier may assign a code (such as an alphanumeric character) to each fare class the airline offers, with the code varying depending on the cabin and the price of the seat; those codes may be different across airline carriers but consistent within a specific airline carrier. Therefore, continuing with this example, in one embodiment, the travel management system 103 may access a mapping between an airline carrier code and a cabin class; for instance, the search result may include an identification of the airline carrier and the codes “Z” and the travel management system 103 may access a mapping to determine that for the identified airline carrier, Z indicates a “business class” category of seats. As another example, within certain airline carriers, multiple codes may each be mapped to the same category of seats depending on whether the flight is domestic vs. international (e.g., using origin/destination to determine domestic or international status), or the type of aircraft and the incline and legroom available with the given seat on that aircraft, or other features as determined by the airline carriers. Each code may be listed in the mapping available to the travel management system 103, which may use the information mapped to each designated code to identify a cabin class. The travel management system 103 may then access a second mapping that indicates for an identified cabin class the initial quality ranking to assign. In some embodiments, there are default categorizations indicating that luxury intercontinental flights that surpass first class standards, that first class is better than business class, which is better than premium economy, which is better than economy, which is better than low cost carrier/basic economy. Not all categorizations may be used in assigning initial quality ratings; for example, the system may execute a rule indicating that luxury intercontinental flights and low cost carrier/basic economy flights should be excluded from a search as unnecessary in, for example, a business travel search; therefore, the system may assign such a quality rating but then remove the search result from the list of results.

The method 200 includes receiving, by the first computing device, from at least one third-party database, for each of the plurality of search results, structured data identifying at least one amenity associated with the search result (208). The travel management system 103 may request the structured data from the third-party amenity database (e.g., from a database provided by an entity such as ATPCO, RouteHappy, or FlightStats). This is in contrast to conventional systems that do not typically provide functionality for performing additional searches for amenity data (third-party or otherwise) but are typically limited to fare listings alone.

The method 200 includes analyzing, by the first computing device, for each of the plurality of search results, the received structured data identifying at least one amenity and the received unstructured data including the at least one rule (210). The travel management system 103 may analyze the structured and unstructured data. Some third-party systems from which the travel management system 103 receives structured data may provide data in the form of “star ratings”, giving a number of “stars” (e.g., one to six, where six is the richest quality) to a ticket based on amenities associated with the ticket. For example, rating a ticket by cabin class alone loses information because cabin classes can be broken out into multiple products with some overlap between the products of differing flights—e.g., first-class tickets for short-haul domestic flights have similar characteristics to business-class seats for longer flights. By including data that describes overall characteristics of the ticket, rather than solely cabin class, the method 200 uses a larger quality space to give a more complete description of flight products available for a given search. This is in contrast to conventional systems, which do not typically provide quality ratings for tickets or provide functionality for accessing the additional feature data that could be used to improve basic quality ratings or create the rule set (e.g., category logic) for determining how to modify an initial quality rating to provide the improved, modified quality rating. It should be understood that although certain examples use star ratings, other categorizations may be implemented, such as number ratings (e.g., 1-6) or other ratings (e.g., standard, enhanced, premium, and luxury instead of one to four stars).

Other data that may be retrieved and analyzed includes, without limitation, airline branding code, pitch of seating, seat reclining options, in-seat entertainment and power features, cabin quality, network connectivity, meals available, meals provided, baggage allowances, and booking flexibility.

In some embodiments, an airline's branding codes (e.g., a specific package of options and features) are mapped to a level of quality. The level of quality may be one generated by the travel management system 103. The level of quality may be one provided by a third-party system, such as that of a third-party providing the third-party amenity database. The level of quality may be used to increase or decrease the initial quality rating.

In analyzing unstructured data, the travel management system 103 may convert the unstructured data into a structured format by applying one or more rules to the unstructured data. For example, the travel management system 103 may apply a rule set to the unstructured data that specifies for a particular category of fare class offered by a particular airline brand, increase the initial quality rating (or decrease the initial quality rating). As another example, the travel management system 103 may include an analysis engine 109 (shown in shadow in FIG. 1A) that can identify patterns within the unstructured data (and/or semi-structured data) that allows the analysis engine 109 to automate the extraction of that information into the travel management system 103 (e.g., to the optional categorization engine 111 shown in shadow in FIG. 1A). As another example, the travel management system 103 may receive unstructured data in the form of fee rules and restrictions, which may include data identifying an amount to be paid for checked luggage or for a seat with an additional amount of legroom or for cancellations by certain dates, and so on; the travel management system 103 may apply one or more rules to the unstructured data to determine how, if at all, each portion of the data impacts the initial quality rating. Other examples of unstructured data include branding assigned to the ticket, equipment used for the flight, and historic flight statistics.

The method 200 includes assigning, by the first computing device, a modified quality rating to at least one of the plurality of search results responsive to the analyzing of the received structured data and of the received unstructured data (212). The travel management system 103 may execute a rule to modify the initial quality rating; for example, the analysis may have indicated that the travel management system 103 should access a particular rule for modifying the initial quality rating and the rule indicates by how much to change the initial quality rating (e.g., whether to increase or decrease the initial rating based on the analyses performed above). The travel management system 103 may receive structured data (e.g., seat pitch/legroom, refundability, baggage inclusion, etc.) and, based on this data, the travel management system 103 may modify the initial quality rating. For example, an economy fare that would be classified at level two based on being economy cabin may be increased to level three if the seat pitch is identified as above standard legroom. Alternatively, an economy fare that would be classified at level two based on being economy cabin may be decreased to level one if it was determined that the fare was non-changeable. A set of rules allows the travel management system 103 to use additional fare details to modify the initial quality rating. If no additional fare details are available, the travel management system 103 may determine not to modify the initial quality rating. The travel management system 103 may modify a data structure (e.g., in the database 120) that stores the initial quality rating, making the modification based on the analyses performed at (210).

The method 200 includes categorizing, by the first computing device, the plurality of search results based on the modified quality rating (214). The method 200 includes categorizing each ticket to ride on a specific flight according to amenities and third-party data and then ranking each flight (each of which may contain one or more ticket options) based on each of the analyses described above.

The method 200 includes displaying, by the first computing device, via a user interface, to a second computing device, an enumeration of each of the plurality of search results categorized based on the quality ratings (216). The second computing device may be the client computing device 102. The user interface engine 105 may generate an instruction for displaying the user interface 107 by the client computing device 102. The user interface 107 may include a user interface element allowing a user to view additional information that is not initially display; for example, an in-context pop-up window or other user interface element may appear with historic flight statistics, providing additional information on historic reliability of a particular flight route. As another example, the user interface 107 may allow the user to select a specific ticket and compare all of the options available from a particular airline.

The user interface 107 may display the enumeration ranking in order of a preference specified by a user of the second computing device. The user may be an administrator managing the preferences for a plurality of individuals. The user may be an individual making a travel reservation on behalf of herself or another individual. User preferences may be pre-programmed, default settings. User preferences may be updated by users providing input to update or modify default settings. A system preference may be, for example, an instruction that if a user books the same flights to/from a particular destination more than a threshold number of times, the system should display those flights for the user first. As another example, if a user only has loyalty club information for one airline in an associated user profile, the system may have an instruction to display flights from that airline on top. As an example, user-entered preferences may include the system noting that a user manually sorts or filters a search result list by price, departure time, arrival time, duration, etc., and the system applying that sorting or filtering in a subsequent display of search results. As an example, administrator preferences could include travel program optimization—for example, if a company has a negotiated rate with a particular airline, or wants the airline displayed as a preferred carrier, then the system may display the airline's options on top of the flights list. As another example, administrator preferences could include an indication that a company has completely barred all employees from traveling through a particular location, or in a particular cabin class, and the system may receive an instruction that those results can be excluded or downgraded in the search results.

In some embodiments, the first computing device receives an identification of a characteristic of a booking history associated with a user of the second computing device. The travel management system 103 may receive the identification of the characteristic of the booking history associated with the user of the second computing device. The travel management system 103 may receive the identification of the characteristic of the booking history associated with the user of the second computing device as unstructured data. The travel management system 103 may receive the identification of the characteristic of the booking history associated with the user of the second computing device as structured data. The travel management system 103 may analyze, for each of the plurality of search results, the received identification of the characteristic of the booking history associated with the user of the second computing device. The travel management system 103 may assign a modified quality rating to at least one of the plurality of search results responsive to the analyzing of the received identification. The travel management system 103 may categorize the plurality of search results based on the modified quality rating. The travel management system 103 may modify, via the user interface 107, the display, to the second computing device, of the enumeration of each of the plurality of search results categorized based on the modified quality ratings. The travel management system 103 may modify, via the user interface 107, the display, to the second computing device, of the enumeration of each of the plurality of search results categorized based on the modified quality ratings after an initial display of the enumeration of each of the plurality of search results as described in above in connection with FIG. 2, (216). The travel management system 103 may categorize the plurality of search results based on the modified quality rating before displaying, via the user interface 107, to the second computing device, of the enumeration of each of the plurality of search results as described in above in connection with FIG. 2, (216).

In some embodiments, the first computing device receives an identification of a membership in a loyalty rewards program associated with a user of the second computing device. The travel management system 103 may receive the identification of the membership in the loyalty rewards program associated with the user of the second computing device. The travel management system 103 may receive the identification of the membership in the loyalty rewards program associated with the user of the second computing device as unstructured data. The travel management system 103 may receive the identification of the membership in the loyalty rewards program associated with the user of the second computing device as structured data. The travel management system 103 may analyze, for each of the plurality of search results, the received identification of the membership in the loyalty rewards program associated with the user of the second computing device. The travel management system 103 may assign a modified quality rating to at least one of the plurality of search results responsive to the analyzing of the received identification. The travel management system 103 may categorize the plurality of search results based on the modified quality rating. The travel management system 103 may modify, via the user interface 107, the display, to the second computing device, of the enumeration of each of the plurality of search results categorized based on the modified quality ratings. The travel management system 103 may modify, via the user interface 107, the display, to the second computing device, of the enumeration of each of the plurality of search results categorized based on the modified quality ratings after an initial display of the enumeration of each of the plurality of search results as described in above in connection with FIG. 2, (216). The travel management system 103 may categorize the plurality of search results based on the modified quality rating before displaying, via the user interface 107, to the second computing device, of the enumeration of each of the plurality of search results as described in above in connection with FIG. 2, (216).

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 3A, 3B, and 3C, block diagrams depict additional detail regarding computing devices that may be modified to execute novel, non-obvious functionality for implementing the methods and systems described above.

Referring now to FIG. 3A, an embodiment of a network environment is depicted. In brief overview, the network environment comprises one or more clients 302a-302n (also generally referred to as local machine(s) 302, client(s) 302, client node(s) 302, client machine(s) 302, client computer(s) 302, client device(s) 302, computing device(s) 302, endpoint(s) 302, or endpoint node(s) 302) in communication with one or more remote machines 306a-306n (also generally referred to as server(s) 306 or computing device(s) 306) via one or more networks 304.

Although FIG. 3A shows a network 304 between the clients 302 and the remote machines 306, the clients 302 and the remote machines 306 may be on the same network 304. The network 304 can be a local area network (LAN), such as a company Intranet, a metropolitan area network (MAN), or a wide area network (WAN), such as the Internet or the World Wide Web. In some embodiments, there are multiple networks 304 between the clients 302 and the remote machines 306. In one of these embodiments, a network 304′ (not shown) may be a private network and a network 304 may be a public network. In another of these embodiments, a network 304 may be a private network and a network 304′ a public network. In still another embodiment, networks 304 and 304′ may both be private networks. In yet another embodiment, networks 304 and 304′ may both be public networks.

The network 304 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 304 may comprise a wireless link, such as an infrared channel or satellite band. The topology of the network 304 may be a bus, star, or ring network topology. The network 304 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 302 and a remote machine 306 (referred to generally as computing devices 300) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 302 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client 302.

In one embodiment, a computing device 306 provides functionality of a web server. In some embodiments, a web server 306 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the ORACLE WEBLOGIC products provided by Oracle Corporation of Redwood Shores, Calif.

In some embodiments, the system may include multiple, logically-grouped remote machines 306. In one of these embodiments, the logical group of remote machines may be referred to as a server farm 338. In another of these embodiments, the server farm 338 may be administered as a single entity.

FIGS. 3B and 3C depict block diagrams of a computing device 300 useful for practicing an embodiment of the client 302 or a remote machine 306. As shown in FIGS. 3B and 3C, each computing device 300 includes a central processing unit 321, and a main memory unit 322. As shown in FIG. 3B, a computing device 300 may include a storage device 328, an installation device 316, a network interface 318, an I/O controller 323, display devices 324a-n, a keyboard 326, a pointing device 327, such as a mouse, and one or more other I/O devices 730a-n. The storage device 328 may include, without limitation, an operating system and software. As shown in FIG. 3C, each computing device 300 may also include additional optional elements, such as a memory port 303, a bridge 370, one or more input/output devices 330a-n (generally referred to using reference numeral 330), and a cache memory 340 in communication with the central processing unit 321.

The central processing unit 321 is any logic circuitry that responds to and processes instructions fetched from the main memory unit 322. In many embodiments, the central processing unit 321 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 300 may be based on any of these processors, or any other processor capable of operating as described herein.

Main memory unit 322 may be one or more memory chips capable of storing data and allowing any storage location to be directly accessed by the main processor 321. The main memory 322 may be based on any available memory chips capable of operating as described herein. In the embodiment shown in FIG. 3B, the processor 321 communicates with main memory 322 via a system bus 350. FIG. 3C depicts an embodiment of a computing device 300 in which the processor communicates directly with main memory 322 via a memory port 303. FIG. 3C also depicts an embodiment in which the main processor 321 communicates directly with cache memory 340 via a secondary bus, sometimes referred to as a backside bus. In other embodiments, the main processor 321 communicates with cache memory 340 using the system bus 350.

In the embodiment shown in FIG. 3B, the processor 321 communicates with various I/O devices 330 via a local system bus 350. Various buses may be used to connect the central processing unit 321 to any of the I/O devices 330, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 324, the processor 321 may use an Advanced Graphics Port (AGP) to communicate with the display 324. FIG. 3C depicts an embodiment of a computing device 300 in which the main processor 321 also communicates directly with an I/O device 330b via, for example, HYPERTRANSPORT, RAPIDIO, or INFINIBAND communications technology.

One or more of a wide variety of I/O devices 330a-n may be present in or connected to the computing device 300, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 323 as shown in FIG. 3B. Furthermore, an I/O device may also provide storage and/or an installation device 316 for the computing device 300. In some embodiments, the computing device 300 may provide USB connections (not shown) to receive handheld USB storage devices such as the USB Flash Drive line of devices manufactured by Twintech Industry, Inc. of Los Alamitos, Calif.

Referring still to FIG. 3B, the computing device 100 may support any suitable installation device 316, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 300 may provide functionality for installing software over a network 304. The computing device 300 may further comprise a storage device, such as one or more hard disk drives or redundant arrays of independent disks, for storing an operating system and other software. Alternatively, the computing device 300 may rely on memory chips for storage instead of hard disks.

Furthermore, the computing device 300 may include a network interface 318 to interface to the network 304 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 300 communicates with other computing devices 300′ via any type and/or form of gateway or tunneling protocol such as Secure Socket Layer (SSL) or Transport Layer Security (TLS). The network interface 318 may comprise a built-in network adapter, network interface card, PCMCIA network card, card bus network adapter, wireless network adapter, USB network adapter, modem, or any other device suitable for interfacing the computing device 300 to any type of network capable of communication and performing the operations described herein.

In further embodiments, an I/O device 330 may be a bridge between the system bus 350 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 3B and 3C typically operates under the control of operating systems, which control scheduling of tasks and access to system resources. The computing device 300 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, and WINDOWS VISTA, WINDOWS 10 all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc., of Raleigh, N.C.; Ubuntu, a freely-available operating system distributed by Canonical Ltd. of London, England; or any type and/or form of a Unix operating system, among others.

Having described certain embodiments of methods and systems for dynamically updating a user interface displaying a listing of air tickets available for purchase on a flight, the listing categorized based on features associated with the tickets, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for displaying and dynamically updating a user interface displaying a listing of air tickets available for purchase on a flight, the listing categorized based on features associated with the air tickets, the method comprising:
receiving, by a first computing device, from a plurality of third-party fare listing systems, a plurality of search results, each search result in the plurality of search results including at least one fare listing for an air ticket for a seat on a flight between an origin and a destination and an identification of a class associated with the air ticket, and unstructured data including at least one rule associated with the search result;
analyzing, by the first computing device, each search result in the plurality of search results;
assigning, by the first computing device, an initial quality rating for each search result in the plurality of search results responsive to the analyzing;
receiving, by the first computing device, from at least one third-party database, for each of the plurality of search results, structured data identifying at least one amenity associated with the search result;
analyzing, by the first computing device, for each of the plurality of search results, the received structured data identifying at least one amenity and the received unstructured data including the at least one rule;
assigning, by the first computing device, a modified quality rating to at least one of the plurality of search results responsive to the analyzing of the received structured data and of the received unstructured data;
categorizing, by the first computing device, the plurality of search results based on the modified quality rating; and
displaying, by the first computing device, via a user interface, to a second computing device, an enumeration of each of the plurality of search results categorized based on the quality ratings.

2. The method of claim 1, wherein displaying further comprises displaying the enumeration ranked in order of a preference specified by a user of the second computing device.

3. The method of claim 1, wherein displaying further comprises displaying the enumeration ranked in order of a preference specified by an administrator of the second computing device.

4. The method of claim 1 further comprising, before receiving the plurality of search results:
receiving, by the first computing device, a search request for air ticket availability between the origin and the destination; and
requesting, by the first computing device, from each of the plurality of third-party fare listing systems, air ticket availability between the origin and the destination.

5. The method of claim 1, wherein assigning the initial quality rating for each search result in the plurality of search results further comprises:
identifying, within each search result, an origin and a destination;
identifying, within each search result, a cabin class;
and
assigning the initial quality ranking to the search result based upon the origin, the destination, and the cabin class.

6. The method of claim 1 further comprising:
receiving, by the first computing device, an identification of a membership in a loyalty rewards program associated with a user of the second computing device;
analyzing, by the first computing device, for each of the plurality of search results, the received identification;
assigning, by the first computing device, a modified quality rating to at least one of the plurality of search results responsive to the analyzing of the received identification;
categorizing, by the first computing device, the plurality of search results based on the modified quality rating; and
modifying, by the first computing device, via the user interface, the display, to the second computing device, of the enumeration of each of the plurality of search results categorized based on the modified quality ratings.

7. The method of claim 1, further comprising, before displaying, via the user interface, the enumeration of each of the plurality of search results categorized based on the quality ratings:
receiving, by the first computing device, an identification of a membership in a loyalty rewards program associated with a user of the second computing device;
analyzing, by the first computing device, for each of the plurality of search results, the received identification;
assigning, by the first computing device, a modified quality rating to at least one of the plurality of search results responsive to the analyzing of the received identification; and
categorizing, by the first computing device, the plurality of search results based on the modified quality rating.

8. The method of claim 1 further comprising:
receiving, by the first computing device, an identification of a characteristic of a booking history associated with a user of the second computing device;
analyzing, by the first computing device, for each of the plurality of search results, the received identification;
assigning, by the first computing device, a modified quality rating to at least one of the plurality of search results responsive to the analyzing of the received identification;
categorizing, by the first computing device, the plurality of search results based on the modified quality rating; and
modifying, by the first computing device, via the user interface, the display, to the second computing device, of the enumeration of each of the plurality of search results categorized based on the modified quality ratings.

9. The method of claim 1, further comprising, before displaying, via the user interface, the enumeration of each of the plurality of search results categorized based on the quality ratings:
receiving, by the first computing device, an identification of a characteristic of a booking history associated with a user of the second computing device;
analyzing, by the first computing device, for each of the plurality of search results, the received identification;
assigning, by the first computing device, a modified quality rating to at least one of the plurality of search results responsive to the analyzing of the received identification; and
categorizing, by the first computing device, the plurality of search results based on the modified quality rating.

10. A non-transitory, computer-readable medium comprising computer program instructions tangibly stored on the non-transitory computer-readable medium, wherein the instructions are executable by at least one processor to perform a method for displaying and dynamically updating a user interface displaying a listing of air tickets available for purchase on a flight, the listing categorized based on features associated with the air tickets, the method comprising:
receiving, by a first computing device, from a plurality of third-party fare listing systems, a plurality of search results, each search result in the plurality of search results including at least one fare listing for an air ticket for a seat on a flight between an origin and a destination and an identification of a class associated with the air ticket, and unstructured data including at least one rule associated with the search result;
analyzing, by the first computing device, each search result in the plurality of search results;
assigning, by the first computing device, an initial quality rating for each search result in the plurality of search results responsive to the analyzing;
receiving, by the first computing device, from at least one third-party database, for each of the plurality of search results, structured data identifying at least one amenity associated with the search result;
analyzing, by the first computing device, for each of the plurality of search results, the received structured data identifying at least one amenity and the received unstructured data including the at least one rule;
assigning, by the first computing device, a modified quality rating to at least one of the plurality of search results responsive to the analyzing of the received structured data and of the received unstructured data;
categorizing, by the first computing device, the plurality of search results based on the modified quality rating; and
displaying, by the first computing device, via a user interface, to a second computing device, an enumeration of each of the plurality of search results categorized based on the quality ratings.

11. The non-transitory, computer-readable medium of claim 10, wherein displaying further comprises displaying the enumeration ranked in order of a preference specified by a user of the second computing device.

12. The non-transitory, computer-readable medium of claim 10, wherein displaying further comprises displaying the enumeration ranked in order of a preference specified by an administrator of the second computing device.

13. The non-transitory, computer-readable medium of claim 10 further comprising, before receiving the plurality of search results:
receiving, by the first computing device, a search request for air ticket availability between the origin and the destination; and
requesting, by the first computing device, from each of the plurality of third-party fare listing systems, air ticket availability between the origin and the destination.

14. The non-transitory, computer-readable medium of claim 10, wherein assigning the initial quality rating for each search result in the plurality of search results further comprises:
identifying, within each search result, an origin and a destination;
identifying, within each search result, a cabin class;
and
assigning the initial quality ranking to the search result based upon the origin, the destination, and the cabin class.

15. The non-transitory, computer-readable medium of claim 10 further comprising:
receiving, by the first computing device, an identification of a membership in a loyalty rewards program associated with a user of the second computing device;
analyzing, by the first computing device, for each of the plurality of search results, the received identification;
assigning, by the first computing device, a modified quality rating to at least one of the plurality of search results responsive to the analyzing of the received identification;
categorizing, by the first computing device, the plurality of search results based on the modified quality rating; and
modifying, by the first computing device, via the user interface, the display, to the second computing device, of the enumeration of each of the plurality of search results categorized based on the modified quality ratings.

16. The non-transitory, computer-readable medium of claim 10, further comprising, before displaying, via the user interface, the enumeration of each of the plurality of search results categorized based on the quality ratings:
receiving, by the first computing device, an identification of a membership in a loyalty rewards program associated with a user of the second computing device;
analyzing, by the first computing device, for each of the plurality of search results, the received identification;
assigning, by the first computing device, a modified quality rating to at least one of the plurality of search results responsive to the analyzing of the received identification; and
categorizing, by the first computing device, the plurality of search results based on the modified quality rating.

17. The non-transitory, computer-readable medium of claim 10 further comprising:
receiving, by the first computing device, an identification of a characteristic of a booking history associated with a user of the second computing device;
analyzing, by the first computing device, for each of the plurality of search results, the received identification;
assigning, by the first computing device, a modified quality rating to at least one of the plurality of search results responsive to the analyzing of the received identification;
categorizing, by the first computing device, the plurality of search results based on the modified quality rating; and
modifying, by the first computing device, via the user interface, the display, to the second computing device, of the enumeration of each of the plurality of search results categorized based on the modified quality ratings.

18. The non-transitory, computer-readable medium of claim 10, further comprising, before displaying, via the user interface, the enumeration of each of the plurality of search results categorized based on the quality ratings:
receiving, by the first computing device, an identification of a characteristic of a booking history associated with a user of the second computing device;
analyzing, by the first computing device, for each of the plurality of search results, the received identification;
assigning, by the first computing device, a modified quality rating to at least one of the plurality of search results responsive to the analyzing of the received identification; and
categorizing, by the first computing device, the plurality of search results based on the modified quality rating.
